(19) United States
(12) Patent Application Publication
(10) Pub. No.: US 2024/0198754 A1
(43) Pub. Date: Jun. 20, 2024

(54) HVAC APPARATUS FOR VEHICLE

(71) Applicants: Hyundai Motor Company, Seoul (KR); Kia Corporation, Seoul (KR); DOOWON CLIMATE CONTROL CO., LTD, Asan-si (KR)

(72) Inventors: Eung-Young KIM, Anyang-Si (KR); Myung-Hoe KIM, Seoul (KR); Yoon-Hyung LEE, Seongnam-Si (KR); Chul-Min JANG, Asan-Si (KR)

(21) Appl. No.: 18/228,493

(22) Filed: Jul. 31, 2023

(30) Foreign Application Priority Data
Dec. 14, 2022 (KR) 10-2022-0175230

(51) Int. Cl. B60H 1/00

(52) U.S. Cl. CPC B60H 1/00028; B60H 2001/00092; B60H 2001/00128

(57) ABSTRACT

An HVAC apparatus for a vehicle that can simplify air flow path therein and occupy a small installation space, includes a housing; an evaporator core provided in parallel with the ground within a predetermined angular range to the ground; an internal condenser provided the evaporator core, and a high voltage PTC provided the internal condenser, the evaporator core, the internal condenser, and the high voltage PTC are provided in parallel with the ground within a predetermined angular range from the ground.

### CROSS-REFERENCE TO RELATED APPLICATION

The present application claims priority to Korean Patent Application No. 10-2022-0175230, filed on Dec. 14, 2022, the entire contents of which is incorporated herein for all purposes by this reference.

### BACKGROUND OF PRESENT DISCLOSURE

### Field of Present Disclosure

The present disclosure relates to a heating, ventilation, and air conditioning (HVAC) apparatus for a vehicle that can simplify air flow path therein and occupy a small installation space.

### Description of Related Art

An HVAC apparatus for internal air conditioning of a vehicle is provided in the vehicle to perform air conditioning by cooling, heating, blowing, and dehumidifying an interior of the vehicle.

As illustrated in FIG. 1, the HVAC apparatus is provided in the front side of a vehicle, that is, at a portion where a dash panel 151 and a floor panel 152 meet. The HVAC apparatus is vertically provided with an evaporator core 121 which is a heat exchanger for cooling, an internal condenser 122 which is a heat exchanger for heating, and a high voltage Positive Temperature Coefficient (PTC) 123, and is disposed in the longitudinal direction of the vehicle. The evaporator core 121, the internal condenser 122, and the high voltage PTC 123 are provided inside a housing 111 in a direction approximately perpendicular to the ground, and air blown by a blower 141 passes through the evaporator core 121, the internal condenser 122, and the high voltage PTC 123 sequentially, and is discharged in a harmonized state. The housing 111 includes a temperature door 131, a floor door 132, a vent door 133, and a defrost door 134 to control a flow path and a discharging direction of air according to an air conditioning mode. Furthermore, to send conditioned air to a second row, a second row duct 112 is provided on one side of the housing 111, and the second row duct 112 is opened or closed by a second row door 135.

During cooling, as illustrated in FIG. 3, the temperature door 131 blocks a flow of air to the internal condenser 122 and the high voltage PTC 123, and the vent door 133 and the second row door 135 are opened. Air flew through the evaporator core 121 is supplied to the first and second rows to cool the room.

During heating, as illustrated in FIG. 4, the temperature door 131 is opened to allow air to flow the internal condenser 122 and the high voltage PTC 123, and the floor door 132 and the second row door 135 are opened. The air is heated through the evaporator core 121, the internal condenser 122 and the high voltage PTC 123, and then is supplied to the first and second rows to heat the room.

The HVAC apparatus according to the conventional technology is provided in a direction perpendicular to the ground, during heating, air is bypassed to pass through the internal condenser 122 and the high voltage PTC 123, and even when supplied to the first and second rows, flow path is rapidly bent and is complicated, increasing ventilation resistance and reducing air volume.

Because the evaporator core 121, the internal condenser 122, and the high voltage PTC 123 are provided perpendicular to the ground, and the internal condenser 122 and the high voltage PTC 123 are located at a rear of the vehicle spaced from the evaporator core 121, a size of the HVAC apparatus is bound to increase. To secure an indoor space (particularly, a space where a passenger's feet are located) of a vehicle and implement a slim cockpit, the size of the HVAC apparatus should be reduced, but this could not be achieved in the HVAC apparatus according to the conventional technology. Because the evaporator core 121, the internal condenser 122, and the high voltage PTC 123 are vertically provided, a space S between a lower end portion of the housing 111 and a floor panel 152 is small, making it difficult to secure enough space for the passenger's feet.

Furthermore, because the air blown from the blower 141 passes around the rear surface of the evaporator core 121, the ventilation resistance is high, and air passes unevenly through the evaporator core 121. Thus there is a problem in that cooling efficiency of the evaporator core 121 is decreased.

Furthermore, because the second row duct 112 is connected to the housing 111 from an internal side of the vehicle, there is a problem that a portion to which the second row duct 112 is connected is exposed in a vehicle without a console or where the console is provided in a sliding manner. An electric vehicle may not include a console or the console may be provided slidably in the longitudinal direction of the vehicle. Accordingly, a portion where the second row duct 112 is connected to the housing 111 is exposed to the interior of the vehicle to impair aesthetics.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY OF PRESENT DISCLOSURE

Various aspects of the present disclosure are directed to providing a heating, ventilation, and air conditioning (HVAC) apparatus for a vehicle which may be miniaturized and increases an indoor space by installing the evaporator core, internal condenser, and high voltage PTC in a direction in parallel with the ground to occupy a small space.

Another object of the present disclosure is to provide an HVAC apparatus for a vehicle in such a manner as to improve air conditioning performance by reducing ventilation resistance to simplify a flow path of air during heating.

To achieve the above object, the HVAC apparatus for a vehicle according to an exemplary embodiment of the present disclosure includes a housing: an evaporator core provided in parallel with the ground within a predetermined angular range with the ground inside the housing: a heating unit provided over the evaporator core: the evaporator core and the heating unit are provided in parallel with the ground within a predetermined angular range with the ground.

As an exemplary embodiment of the present disclosure, a second row heating flow path through which air flew through the heating unit flows toward a second row side may be formed inside the housing, and a second row cooling flow path through which air flew through the evaporator core flows toward the second row side, bypassing the heating unit without passing therethrough, may be formed inside the housing.

As an exemplary embodiment of the present disclosure, a second row temperature door for opening or closing the second row heating flow path may be provided in the second row heating flow path.

As an exemplary embodiment of the present disclosure, the second row heating flow path and the second row cooling flow path may be formed on a surface facing a dash panel and connected to a second row duct for supplying conditioned air to a second row.

As an exemplary embodiment of the present disclosure, a second row opening and closing portion where the second row duct may be connected in the housing.

As an exemplary embodiment of the present disclosure, a guide for distributing and guiding air flew through the evaporator core to the first row or the second row may be formed at the front end portion of the heating unit.

As an exemplary embodiment of the present disclosure, the second row cooling flow path may be formed between the guide and the evaporator core.

As an exemplary embodiment of the present disclosure, the second row heating flow path may be formed in a portion adjacent to the dash panel to bypass the front end portion of the heating unit from an upper portion of the housing.

As an exemplary embodiment of the present disclosure, a defrost outlet which discharges conditioned air into a windshield and opens or closes with a defrost door, and a vent outlet which discharges conditioned air into an interior of a vehicle and opens or closes with a vent door may be formed on an upper surface of the housing, and the evaporator core and the heating unit may be disposed below the defrost outlet and the vent outlet.

As an exemplary embodiment of the present disclosure, a floor outlet which discharges conditioned air with a floor of the vehicle and opens or closes with a floor door may be formed on one side of the housing.

As an exemplary embodiment of the present disclosure, a temperature door may be provided between the evaporator core and the heating unit.

As an exemplary embodiment of the present disclosure, a first row heating flow path through which air flew through the evaporator core flows to the heating unit and a first row cooling flow path through which air flew through the evaporator core bypasses the heating unit may be formed on an upper portion of the evaporator core.

As an exemplary embodiment of the present disclosure, the temperature door selectively may open the first row heating flow path and the first row cooling flow path.

As an exemplary embodiment of the present disclosure, the heating unit may include an internal condenser provided over the evaporator core, and a PTC provided over the internal condenser.

As an exemplary embodiment of the present disclosure, a bottom surface of the housing may be formed as an inclined surface.

As an exemplary embodiment of the present disclosure, a drain may be formed at a bottom portion of the inclined surface.

As an exemplary embodiment of the present disclosure, a blower duct through which air blown from a blower flows to the housing may be formed, the blower duct may be connected to the housing lower than the evaporator core.

According to the HVAC apparatus for a vehicle of the present disclosure with the configuration, by horizontally disposing the evaporator core, the internal condenser, and the high voltage PTC, miniaturization may be achieved.

As an air conditioning unit becomes smaller, an indoor space of a vehicle increases.

Furthermore, ventilation resistance is reduced inside the air conditioning unit, improving air conditioning performance.

Furthermore, as the part of the second row duct connected to the housing is located between the dash panel and the air conditioning unit, even though there is no console or a sliding type console is applied, it is not exposed, improving the aesthetics.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram illustrating a heating, ventilation, and air conditioning (HVAC) apparatus for a vehicle in the related art.

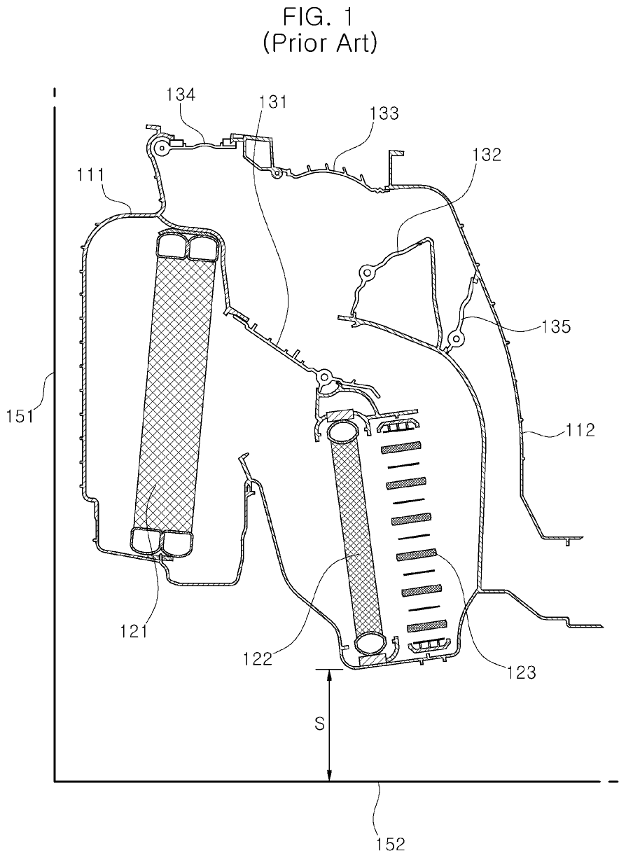

FIG. 2 is a schematic diagram illustrating a state where a blower is provided in the HVAC apparatus for a vehicle in the related art.

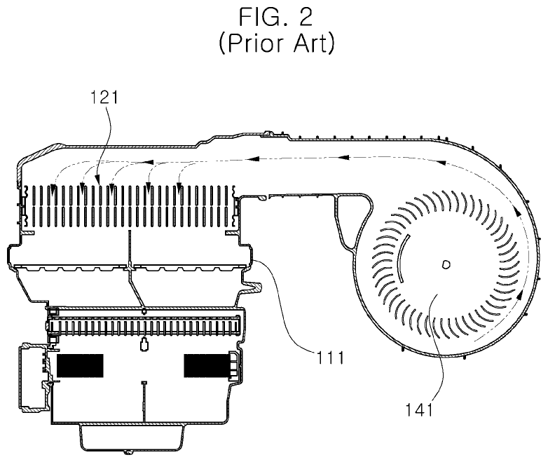

FIG. 3 is a schematic diagram illustrating a state where the HVAC apparatus for a vehicle in the related art operates during cooling.

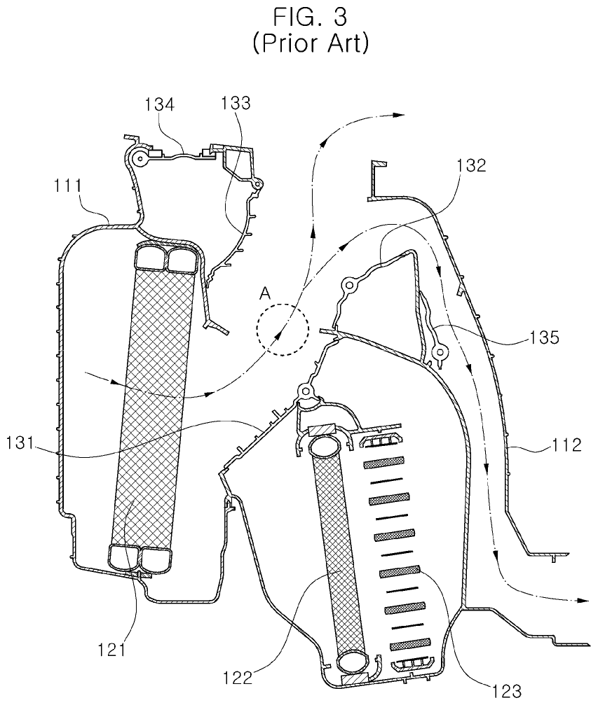

FIG. 4 is a schematic diagram illustrating a state where the HVAC apparatus for a vehicle in the related art operates during heating.

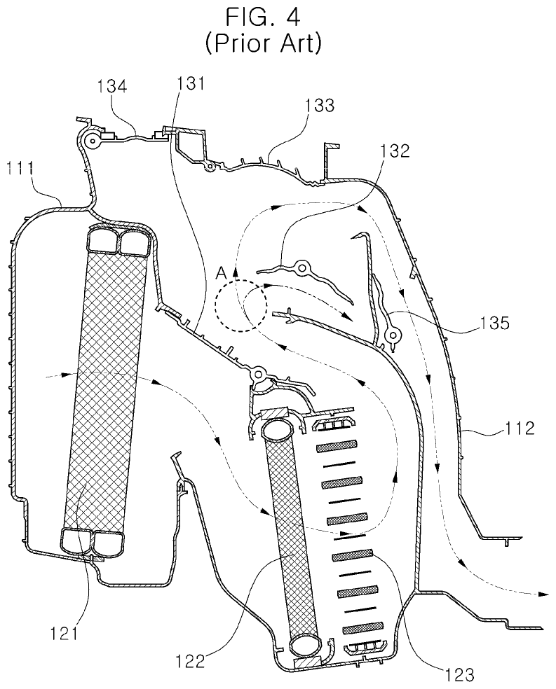

FIG. 5 is a schematic diagram illustrating an HVAC apparatus for a vehicle according to an exemplary embodiment of the present disclosure.

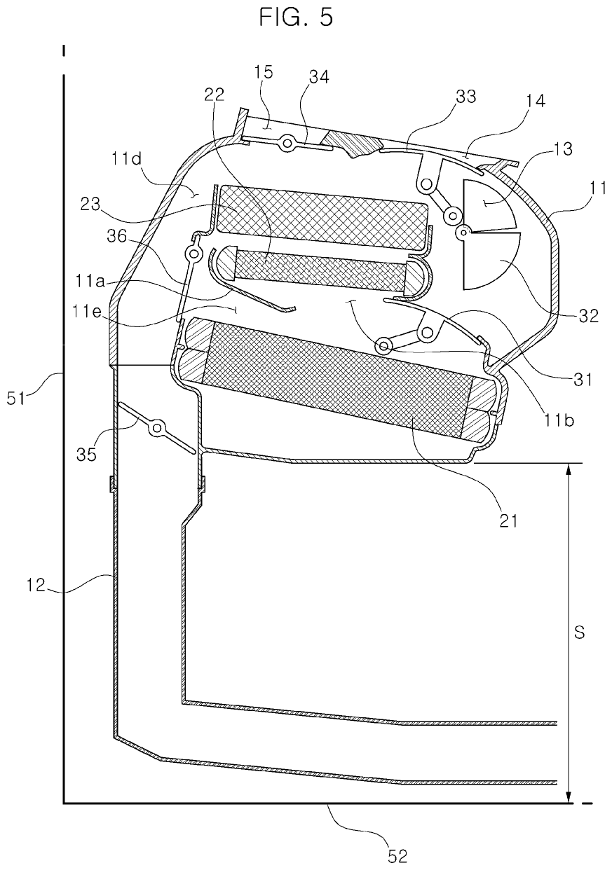

FIG. 6 is a schematic diagram illustrating a state where the HVAC apparatus for a vehicle according to an exemplary embodiment of the present disclosure operates during cooling.

FIG. 7 is a schematic diagram illustrating a state where the HVAC apparatus for a vehicle according to an exemplary embodiment of the present disclosure operates during heating.

FIG. 8 is a schematic diagram illustrating a state where a blower is provided in the HVAC apparatus for a vehicle according to an exemplary embodiment of the present disclosure.

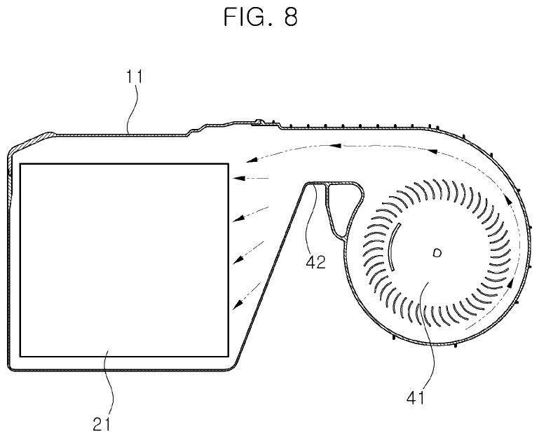

FIG. 9 is an enlarged perspective diagram of a main portion illustrating a bottom surface of a housing in the HVAC apparatus for a vehicle according to an exemplary embodiment of the present disclosure.

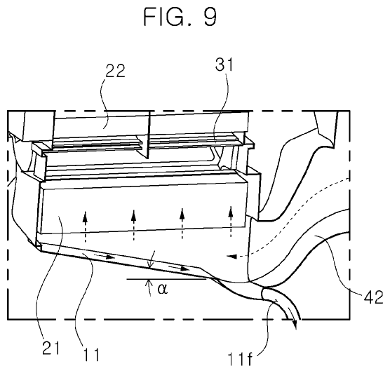

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an HVAC apparatus for a vehicle according to an exemplary embodiment of the present disclosure will be described in detail with reference to the accompanying drawings.

An HVAC apparatus for a vehicle according to an exemplary embodiment of the present disclosure includes a housing 11, an evaporator core 21 provided in parallel with the ground within a predetermined angular range, an internal condenser 22 provided over the evaporator core 21, and a PTC 23 provided over the internal condenser 22. The evaporator core 21, the internal condenser 22, and the high voltage PTC 23 are provided in parallel with the ground within a predetermined angular range from the ground.

The housing 11 includes a space therein, and the evaporator core 21 and a heating unit are provided therein. Air introduced inside the housing 11 passes through some or all of the evaporator core 21 and the heating units to condition air to a temperature set by a passenger or an air conditioning system.

The evaporator core 21 is disposed inside the housing 11. The evaporator core 21 is disposed in parallel with the ground inside the housing 11. In the evaporator core 21, refrigerant and air flowing through the evaporator core 21 exchange heat to decrease a temperature of air flowing through the evaporator core 21.

The heating unit includes the internal condenser 22 and the high voltage PTC 23.

The internal condenser 22 is provided over the evaporator core 21 in the housing 11. The internal condenser 22 is a heat exchanger in which refrigerant and air exchange heat to raise a temperature of air flowing through the internal condenser 22, and is disposed in parallel with the ground, like the evaporator core 21.

The high voltage PTC 23 is provided over the internal condenser 22. When electric power is applied to the high voltage PTC 23, the high voltage PTC 23 raises a temperature of air flowing through the high voltage PTC 23. Compared to fact that the internal condenser 22 raises a temperature of air when refrigerant is circulated, the high voltage PTC 23 may immediately raise a temperature of air when power is applied. Likewise, the high voltage PTC 23 is also provided in parallel with the ground.

Due to the evaporator core 21, the internal condenser 22, and the high voltage PTC 23 being provided to be stacked on top of each other in the vertical direction, air flew through the evaporator core 21 may not be bypassed to flow into the internal condenser 22 and the high voltage PTC 23. Therefore by reducing flow path, ventilation resistance is reduced.

The evaporator core 21, the internal condenser 22, and the high voltage PTC 23 are disposed in parallel with the ground. Herein, an arrangement in parallel with the ground means that the evaporator core 21, the internal condenser 22, and the high voltage PTC 23 are disposed in parallel with the ground within a predetermined angle. For example, the evaporator core 21, the internal condenser 22, and the high voltage PTC 23 may be disposed in parallel with the ground within 20 degrees of the ground.

A temperature door 31 is provided between the evaporator core 21 and the internal condenser 22. The temperature door 31 controls whether air flowing through the evaporator core 21 flows to the internal condenser 22 or bypasses the internal condenser 22.

The temperature door 31 is slidably provided between the evaporator core 21 and the internal condenser 22. The temperature door 31 is slidably provided at a rear side of the vehicle below the internal condenser 22.

Between the evaporator core 21 and the internal condenser 22, a guide 11a is formed in an area where the temperature door 31 is not provided, that is, below the internal condenser 22. The guide 11a is formed in the remaining area of the front side of the vehicle where the temperature door 31 is not provided. The guide 11a distributes and guides air flew through the evaporator core 21 in the first or second rows at the front end portion of the internal condenser 22.

Furthermore, a floor door 32, a vent door 33, and a defrost door 34 are formed to open or close a floor outlet 13, a vent outlet 14, and a defrost outlet 15, respectively. The defrost outlet 15 and the vent outlet 14 are formed on the upper portion of the housing 11 and then supply conditioned air in the first row with an internal surface of a front glass window. The floor outlet 13 is formed on one side of the housing 11, and conditioned air is supplied with a first row of a floor panel 52.

Because the evaporator core 21, the internal condenser 22, and the high voltage PTC 23 are disposed and stacked in parallel with the ground, the evaporator core 21, the internal condenser 22, and the high voltage PTC 23 are disposed below the defrost outlet 15 and the vent outlet 14.

The housing 11 is formed with a flow path for transmitting conditioned air during cooling and heating in the first and second rows, respectively. That is, in the housing 11, a first row heating flow path 11b for heating in the first row, a first row cooling flow path 11c for cooling in the first row, a second row heating flow path 11d for heating in the second row, and a second row cooling flow path Ile for cooling in the second row are formed.

The first row heating flow path 11b is formed on the upper portion of the evaporator core 21. Air flows through the evaporator core 21, the internal condenser 22 and the high voltage PTC 23 sequentially. Accordingly, the first row heating flow path 11b becomes a path supplied heated air to the first row.

The first row cooling flow path 11c becomes a path through which air flew through the evaporator core 21 is supplied cooled air to the first row by bypassing the internal condenser 22.

The first row heating flow path 11b and the first row cooling flow path 11c are divided by the temperature door 31, and the first row heating flow path 11b and the first row cooling flow path 11c are opened according to a position of the temperature door 31.

The second row heating flow path 11d becomes a path through which air flew through the high voltage PTC 23 flows to a second row duct 12 inside the housing 11. The second row heating flow path 11d is formed inside the housing 11 and is formed to bypass the upper portion of the housing 11 toward a front side of the housing 11. That is, the second row heating flow path 11d is formed in a portion adjacent to a dash panel 51 to bypass the front end portions of the internal condenser 22 and the high voltage PTC 23 above the housing 11. A second row temperature door 36 is provided in the second row heating flow path 11d. The second row temperature door 36 is opened or closed according to an air conditioning mode of the second row temperature door 36. For example, the second row temperature door 36 is opened when heated air is blown to the second row, but closed when cooled air is blown.

A second row cooling flow path Ile is configured between the guide 11a and the evaporator core 21. Air cooled by the evaporator core 21 is directly supplied to the second row through the second row cooling flow path 11e. The second row cooling flow path 11e is joined with the second row heating flow path 11d to be connected to the second row duct 12.

The second row duct 12 for supplying conditioned air to the second row is connected to the housing 11. The second row duct 12 is connected to a surface facing a dash panel 51 from the housing 11.

Because the second row duct 12 is connected to the surface facing the dash panel 51 from the housing 11, a connection portion is invisible to an interior of a vehicle, so that a console is not applied or aesthetics is improved in a vehicle where the console slides.

Meanwhile, a second row opening and closing door 35 is provided at a portion to which the second row duct 12 is connected in the housing 11. Because the second row opening and closing door 35 is controlled to be opened or closed independently, it is opened only when the second row of air conditioning is required, otherwise it is closed. For example, in the case of a defrost mode or a driver's seat-only mode to remove moisture from an internal surface of a front glass window, the second row opening and closing door 35 may be closed because conditioned air does not need to be sent to the second row. Alternatively, by controlling an opening amount of the second row opening and closing door 35, it is also possible to control individually so that air volumes of the first and the second rows are different from each other. Furthermore, the second row temperature door 36 is also controlled together with the second row opening and closing door 35, it is also possible to control individually so that temperatures of the first and second rows are also different.

Meanwhile, a bottom surface of the housing 11 is formed as an inclined surface. Because the bottom surface of the housing 11 is formed as the inclined surface with a predetermined inclination angle α, condensed water generated in the evaporator core 21 may easily move to one side along the inclined surface. A drain 11f is formed at the lowest point of the bottom portion of the housing 11, that is, at the lower end portion of the inclined surface, so that the condensed water may be easily discharged to the outside.

Because the evaporator core 21, the internal condenser 22, and the high voltage PTC 23 are formed in parallel with the ground, a space S between the bottom surface of the housing 11 and a floor panel 52 of the vehicle is widened. Accordingly, the space in which a passenger's feet are located is widened, providing comfort.

A blower 41 blows to a lower portion of the housing 11. A blower duct 42 is provided to guide air blown from the blower 41 from the blower 41 to the housing 11.

The air blown from the blower 41 flows into the bottom surface of the housing 11 and flows upwards from the bottom surface of the housing 11. To the present end, the blower duct 42 is connected to the housing 11 lower than the evaporator core 21.

An operation of the HVAC apparatus for a vehicle according to an exemplary embodiment of the present disclosure having the above configuration is as follows.

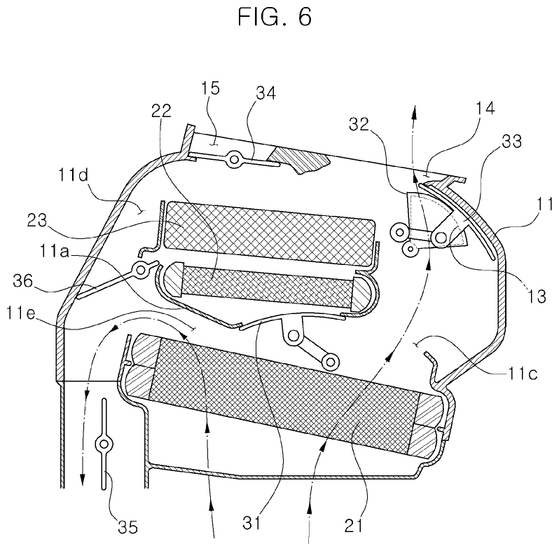

FIG. 6 illustrates an operation state during cooling.

When an air conditioning unit is operated in a cooling mode by the passenger of the vehicle or an air conditioning system of the vehicle, air blown from the blower 41 passes only the evaporator core 21 and is blown to the first row or the second row.

When the air conditioning unit is operated in the cooling mode, the temperature door 31 closes the first row heating flow path 11b, and a second row temperature door 36 closes the second row heating flow path 11d. Accordingly, air cooled by the evaporator core 21 flows through the first row cooling flow path 11c and the second row cooling flow path 11e.

The air blown by the blower 41 is cooled while flowing through the evaporator core 21 and supplied to the first row of the vehicle through the first row cooling flow path 11c and the vent outlet 14 in a cooled state. Meanwhile, some of air flew through the evaporator core 21 flow through the second row cooling flow path Ile and is supplied to the second row of the vehicle through the second row duct 12.

In the cooling mode, the floor door 32 closes the floor outlet 13.

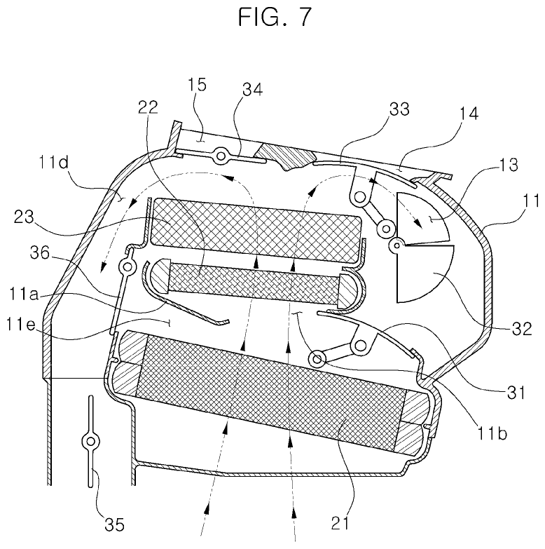

FIG. 7 illustrates an operation state during heating.

When the air conditioning unit is operated in a heating mode by the passenger of the vehicle or the air conditioning system of the vehicle, air blown from the blower 41 flows through the first row heating flow path 11b and the second row heating flow path 11d. The air blown from the blower 41 flows through the evaporator core 21, the internal condenser 22, and the high voltage PTC 23, and is conditioned to a temperature set by the passenger or a temperature set by the air conditioning system. Some of the conditioned air is discharged to the floor outlet 13 in which the floor door 32 is opened through the first row heating flow path 11b to heat the first row of the vehicle. Furthermore, the rest of the conditioned air is supplied to the second row of the vehicle through the second row heating flow path 11d and the second row duct 12, and the second row of the vehicle is heated. In the instant case, because the first row heating flow path 11b flows through the evaporator core 21, the internal condenser 22, and the high voltage PTC 23 sequentially without bypassing therethrough, an effect of reducing ventilation resistance and increasing of air volume may be obtained. Accordingly, the interior of the vehicle may be rapidly heated or capacity of the blower 41 may be reduced.

In a state where heating or cooling in the second row is not required, such as in a defrost mode or driver's seat-only mode, heating or cooling is performed while the second row opening and closing door 35 is closed.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A heating, ventilation, and air conditioning (HVAC) apparatus for a vehicle, the apparatus comprising:
a housing:
an evaporator core provided inside the housing in parallel with the ground within a predetermined first angular range with the ground; and
a heating unit provided over the evaporator core,
wherein the evaporator core and the heating unit are provided in parallel with the ground within a predetermined second angular range.

2. The HVAC apparatus of claim 1, wherein the predetermined first angular range is a first acute angle and the predetermined second angular range is a second acute angle.

3. The HVAC apparatus of claim 1,
wherein a second row heating flow path through which air flew through the heating unit flows toward a second row side is formed inside the housing, and
wherein a second row cooling flow path through which air flew through the evaporator core flows toward the second row side, bypassing the heating unit without passing therethrough, is formed inside the housing.

4. The HVAC apparatus of claim 3, wherein a second row temperature door for opening or closing the second row heating flow path is provided in the second row heating flow path.

5. The HVAC apparatus of claim 3, wherein the second row heating flow path and the second row cooling flow path are formed on a surface facing a dash panel and connected to a second row duct for supplying conditioned air to a second row.

6. The HVAC apparatus of claim 5, wherein a second row opening and closing door for opening or closing the second row duct is provided at a portion where the second row duct is connected in the housing.

7. The HVAC apparatus of claim 6, wherein the second row duct for supplying the conditioned air to the second row is connected to the housing and is connected to a surface of the housing facing the dash panel.

8. The HVAC apparatus of claim 3, wherein a guide for distributing and guiding the air flew through the evaporator core to a first row or a second row is formed at a front end portion of the heating unit.

9. The HVAC apparatus of claim 8, wherein the second row cooling flow path is formed between the guide and the evaporator core.

10. The HVAC apparatus of claim 3, wherein the second row heating flow path is formed in a portion adjacent to a dash panel to bypass an front end portion of the heating unit from an upper portion of the housing.

11. The HVAC apparatus of claim 1, further including:
a defrost door and a defrost outlet formed on an upper surface of the housing and configured to discharge conditioned air into a windshield and open or close with the defrost door; and
a vent door and a vent outlet formed on the upper surface of the housing and configured to discharge conditioned air into an interior of the vehicle and open or close with the vent door,
wherein the evaporator core and the heating unit are disposed under the defrost outlet and the vent outlet.

12. The HVAC apparatus of claim 1, further including a floor door and a floor outlet formed on a side of the housing and configured to discharge conditioned air and open or close with the floor door.

13. The HVAC apparatus of claim 1, further including a temperature door provided between the evaporator core and the heating unit.

14. The HVAC apparatus of claim 13, wherein a first row heating flow path through which air flew through the evaporator core flows to the heating unit and a first row cooling flow path through which air flew through the evaporator core bypasses the heating unit are formed on an upper portion of the evaporator core.

15. The HVAC apparatus of claim 14, wherein the temperature door is configured to selectively open the first row heating flow path and the first row cooling flow path.

16. The HVAC apparatus of claim 1, wherein the heating unit includes:
an internal condenser provided over the evaporator core; and
a Positive Temperature Coefficient (PTC) provided over the internal condenser.

17. The HVAC apparatus of claim 1, wherein a bottom surface of the housing is formed as an inclined surface.

18. The HVAC apparatus of claim 17, wherein a drain is formed at a bottom portion of the inclined surface.

19. The HVAC apparatus of claim 1, further including a blower and a blower duct through which air blown from the blower flows to the housing,
wherein the blower duct is connected to the housing lower than the evaporator core.
